(19) United States
(12) Patent Application Publication
(10) Pub. No.: US 2004/0148851 A1
(43) Pub. Date: Aug. 5, 2004

(54) Method for converting coal to coke

(76) Inventor: George Montgomery, Rose Hill, VA (US)

Correspondence Address: PITTS AND BRITTIAN P C, P O BOX 51295, KNOXVILLE, TN, 37950-1295, US

(21) Appl. No.: 10/354,425

(22) Filed: Jan. 30, 2003

(51) Int. Cl. C10B 53/00; B01D 45/00

(52) U.S. Cl. 44/607; 201/4; 201/8; 201/24

(57) ABSTRACT

A method is provided for converting coal to coke by the steps of blending pulverized coal with water and a binder to a kneadable dough; and baking said dough in a reducing environment.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to the conversion of pulverized coal to coke. More particularly, this invention pertains to a method for substantially reducing the period of time required to accomplish the conversion of pulverized coal to coke.

2. Description of the Related Art

Coke is essentially a high carbon, high heat, clean burning fuel used primarily in steel-making blast furnaces and other industrial applications. It is commonly made from metallurgical coal, which is heated in the absence of oxygen in large ovens. Volatile matter is driven off, leaving fixed carbon. In one process, raw coal is ground to less than 8 mesh (2.362 mm) particle diameter. The ground coal is heated in a fluidized bed to 500° C. to drive off tarry components. The remaining coal is then heat treated at 800° C. to form a calcinate. The tarry components previously driven off are dehydrated and oxidized to form a binder. The calcinate and binder are blended and formed into briquettes, which are cured at 200° C. in air and then treated in a reducing environment at 1000° C.

In most coal-to-coke conversion methods, the period of time required in the reducing environment is extensive, up to 20 hours. It is expensive to maintain the elevated temperatures in the reducing environment for the extended period of time. Moreover, the extended period of time in the reducing environment requires large ovens to provide the necessary volumes of coke required. Accordingly, it is desirable to provide an economical method for converting coal to coke that requires substantially shortened periods of time in a reducing environment, as compared to current methods.

There is a large and ready supply of coal fines, i.e. coal particles less than about 5 millimeters. The coal fines are generally stockpiled, useless in most cases and potentially dangerous to the environment. Accordingly, it is desirable to provide an economical method for converting coal to coke that uses coal fines. It is also desirable to coke high ash coals. High ash coal having an ash content greater than 8% and btu content of less than 14,000 is generally not considered acceptable for making coke.

### DESCRIPTION OF THE INVENTION

In accordance with the present invention, a binder comprising acrylic latex, polyvinyl acetate, ethyl vinyl acetate or starch, for example, is blended with granulated and/or pulverized coal and water to develop a consistency similar to bread dough, a kneadable texture. Two suitable binders were National 13-2216 and Vinyl Dex 32-3547, both available from the National Starch and Chemical Company. The mixture may be extruded or formed into briquettes, for example. Thereafter, the mixture is baked at a temperature of between about 1100° Fahrenheit and about 1200° Fahrenheit in a reducing environment for a period of time between about one hour and about three hours and then air cooled. The resulting coke product exhibits substantially reduced cost per btu, as well as being easily transported and safely stored.

### EXAMPLE 1

A dough was formed with the following ingredients:

3 cups of pulverized non-metallurgical coal

1 cup of granulated coal (1 to 5 mm)

1 ounce of latex binder (Nalco 9838 Latex)

Water to achieve a kneadable texture

The dough was placed in a Styrofoam box and placed on a grate over a wood fire in a brick-walled, steel-topped kiln for approximately one hour, then air-cooled. The resulting product was porous coke having the following analysis:

| | |
|---|---|
| Moisture: | 5.08% |
| Ash | 18% |
| Volatiles | 10.23% |
| Fixed Carbon | 66.18% |
| Sulfur | 0.82% |
| BTU/pound | 11,568 |

### EXAMPLE 2

A dough was formed with the following ingredients:

9 cups of pulverized metallurgical coal

3 cups of granulated coal (1 to 5 mm)

1 cup of crumb rubber (ground tires)

3 ounces of latex binder (Nalco 9838 Latex)

Water to achieve a kneadable texture

The dough was placed in a stainless steel bowl with a lid and placed on a grate over a wood fire in a brick-walled, steel-topped kiln for approximately five hours, then air-cooled. The resulting product was porous coke having the following analysis:

| | |
|---|---|
| Moisture: | 0.85% |
| Ash | 21.64% |
| BTU/pound | 11,532 |

Using the method of the present invention, even high ash coals, having an ash content greater than 8% and btu content of less than 14,000 can be converted to soft coke.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

I claim:

1. A method for converting coal to coke comprising the steps of:
blending pulverized coal with water and a binder to a kneadable dough; and
baking said dough in a reducing environment.

2. A method in accordance with claim 1 wherein said baking step is at temperatures in the range of 1100 to 1200 degrees Fahrenheit.

3. A method in accordance with claim 1 wherein said baking step extends for a period of one to three hours.

4. A method in accordance with claim 1 wherein said binder is selected from a group comprising acrylic latex, starch, polyvinyl acetate and ethyl vinyl acetate.

5. A method in accordance with claim 1 wherein said coal has an ash content in excess of 8%.

6. A combustible product produced by the process of:
blending pulverized coal with water and a binder to a kneadable dough; and
baking said dough in a reducing environment.

67 A combustible product in accordance with claim 6 wherein said baking step is at temperatures in the range of 1100 to 1200 degrees Fahrenheit.

78 A combustible product in accordance with claim 6 wherein said baking step extends for a period of one to three hours.

9. A combustible product in accordance with claim 6 wherein said binder is selected from a group comprising acrylic latex, starch, polyvinyl acetate and ethyl vinyl acetate.

10. A combustible product in accordance with claim 6 wherein said coal has an ash content in excess of 8%.
